(19) United States
(12) Patent Application Publication
(10) Pub. No.: US 2023/0027662 A1
(43) Pub. Date: Jan. 26, 2023

(54) BEDSORE RELIEVING BED

(71) Applicant: Ruth Mendoza Nonnemaker, Lake Elsinore, CA (US)

(72) Inventor: Ruth Mendoza Nonnemaker, Lake Elsinore, CA (US)

(21) Appl. No.: 17/868,619

(22) Filed: Jul. 19, 2022

Related U.S. Application Data
(60) Provisional application No. 63/223,944, filed on Jul. 20, 2021.

(51) Int. Cl. A61G 7/057

(52) U.S. Cl. CPC A61G 7/05707; A61G 7/05784

(57) ABSTRACT

The present invention is a bed for relieving bed sores and other contact related discomfort while lying in bed, which provides a solution to the problem of contact or pressure related discomfort or injury while lying in bed especially if bedridden for a significant amount of time. The core components of the invention are a first support layer and a second support layer with a first opening defined vertically in the first support layer and the second support layer and at least one second opening defined horizontally through the first support layer. Generally speaking, the components are configured as follows: The second support layer is above and fixed to the first support layer, first opening, and the at least one second opening allow air flow to the back or other exposed body part of a person laying on the bed.

### CROSS REFERENCE TO RELATED APPLICATIONS

This application is a non-provisional application claiming priority to U.S. Provisional Patent No. 63/223,944 filed on Jul. 20, 2021, which is incorporated in its entirety.

### BACKGROUND

Bed sores are a significant source of discomfort for people who are bed ridden. Bed sores can even lead to infection, sepsis, and death if they are not treated quickly or adequately. Bed sores are skin lesions caused by constant pressure on the skin that reduces blood circulation. Bed sores are most common in hospice and coma patients but can also affect postoperative patients and people with broken bones (such as the pelvis or femur/hip) that require bed rest for recovery.

Bed sores most commonly occur on the skin in the area on the back of a person where there is little tissue between the person's bones and the skin. These areas include the skin over the shoulder blades (thoracic area), skin over the hips and tailbone (pelvic and coccyx area), and the skin over the spine (especially the lumbar area).

Treatments for bed sores generally include rotating resting positions between sides and back to reduce time that pressure is on any given spot. Improved air circulation to affected areas is also important to reduce bacterial growth and allow sweat and other moisture to evaporate. However, some patients such those with a broken pelvis or hip cannot be rotated.

Some mattress toppers exist with cut outs to reduce pressure on specific areas. However, these mattress toppers do not improve air circulation and so the cut outs can become areas of warm moist air trapped between the body of the person, mattress topper, and mattress. The warm moist air can grow bacteria, yeast, fungus, and other infectious pathogens. The presence of these pathogens can significantly reduce the effectiveness of the mattress toppers in helping bed sores to heal.

### SUMMARY

The disclosed device is unique when compared with other known devices and solutions because it provides a bed with areas of no pressure and improved air circulation. The disclosed device is unique in that it is structurally different from other known devices or solutions. More specifically, the device is unique due to the presence of: a vertical opening connected to horizontal openings to create areas of no pressure with air circulation.

### BRIEF DESCRIPTION OF DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure

FIG. 1 shows an example top-front view of a first bed.

FIG. 2 shows an example side-top view of the first bed.

FIG. 3 shows an example side view of the first bed.

FIG. 4 shows an example foot view of the first bed.

FIG. 5 shows an example head view of the first bed.

FIG. 6 shows an example top-front view of a second bed.

FIG. 7 shows an example side-top view of the second bed.

FIG. 8 shows an example top-front view of a third bed.

FIG. 9 shows an example side-top view of the third bed.

FIG. 10 shows an example side view of a fourth bed.

FIG. 11 shows an example foot view of the fourth bed.

FIG. 12 shows an example head view of the fourth bed.

FIG. 13 shows an example side-top view of a fifth bed.

FIG. 14 shows an example view of a sixth bed.

FIG. 15 shows another view of the sixth bed.

FIG. 16 shows another view of the sixth bed.

### DETAILED DESCRIPTION

In the Summary above, in this Detailed Description, the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range including that number (which may be a range having an upper limit or no upper limit, depending on the variable being defined). For example, “at least 1” means 1 or more than 1. The term “at most” followed by a number is used herein to denote the end of a range, including that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)— (a second number),” this means a range whose limits include both numbers. For example, “25 to 100” means a range whose lower limit is 25 and upper limit is 100 and includes both 25 and 100.

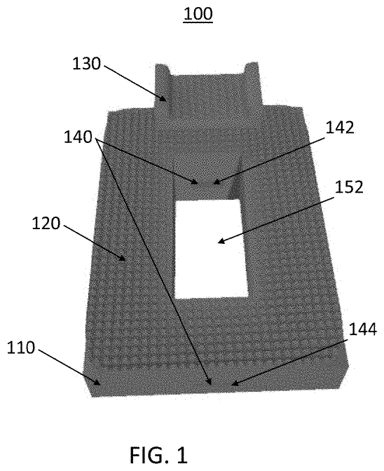

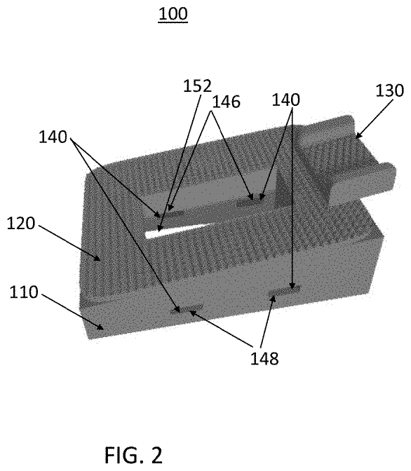

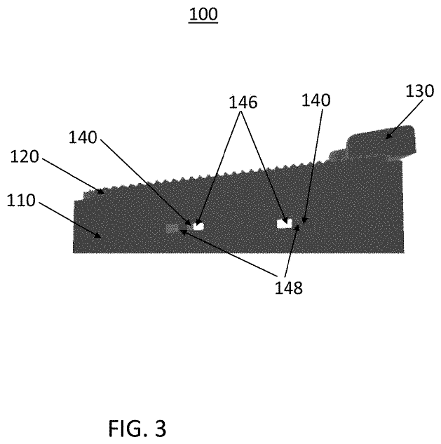

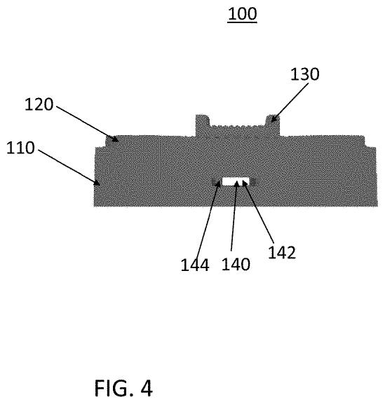

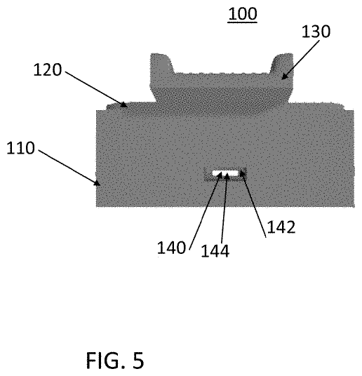

FIGS. 1-5 show an example first bed 100. FIG. 1 shows an example top-front view of a first bed 100. FIG. 2 shows an example side-top view of the first bed 100. FIG. 3 shows an example side view of the first bed 100. FIG. 4 shows an example foot view of the first bed 100. FIG. 5 shows an example head view of the first bed 100. The first bed 100 may include a primary mattress 110, a mattress topper 120, and a headrest 130. The primary mattress 110 and the mattress topper 120 may define a first opening 152 vertically through (entirely or at least partially through) the bed 100. The primary mattress 110 may define a plurality of second openings 140 that extend horizontally from the first opening to an exterior of the bed 100 (i.e., connecting air in the first opening to air outside the bed 100). The second openings 140 may extend through all sides (i.e., head, foot, left, and right sides) of the primary mattress 110 (e.g., head second opening 142, foot second opening 144, left second openings 146 and right second openings 148). The primary mattress 110 and mattress topper 120 may together be considered a mattress. The mattress topper 120 may be above and aligned with the primary mattress 110. The head second opening 142 and the foot second opening 144 may be aligned such that air may pass directly through the head second opening 142 and the foot second opening 144. The left second openings 146 and the right second openings 148 may be aligned such that air may pass directly through the left second openings 146 and the right second openings. This alignment of the openings may help to increase air circulation to the first opening 152 and to the area of the person over the first opening 152.

In some embodiments, the second openings may be about 4-6 inches wide and 2-3 inches high. The first opening 152 may be rectangular in shape and sized to extend from the thoracic area of a person to the coccyx region of a person. Approximately, 30-40 inches in length (head to foot of the bed) for most adults and 10-13 inches in width (left to right sides of the bed). However, for children, smaller than average people or larger than average people the size may be customized. The first opening 152 should not be so large that the person would fall into the first opening. Support to the person's body may be given at the shoulders, along the sides, and across the glutes to ensure the comfort of the user. The first opening 152 may be rectangular in shape or have another shape that allows for pressure to be relieved at the thoracic region, lumbar region, coccyx region, and pelvic region of the user's body.

The primary mattress 110 may include a foam material such as memory foam. The primary mattress 110 may also include springs, batting, quilting, and other materials used in mattresses. The first opening 152 and the second openings 140 may be formed by cutting out portions of the primary mattress 110. The mattress topper 120 may include a material that is softer (in one or both of compression and feel) material than the material of the primary mattress 110. For example, the mattress topper 120 may include a foam that is more compressible than a foam of the primary mattress 110. As another example, the mattress topper 120 may include quilted areas filled with batting which is soft and compressible. The mattress topper may serve to improve comfort of a user by providing a soft surface and spreading the support of the body of the person across a greater area than the firmer primary mattress 110 would allow. The headrest 130 may be include a foam material, padded material, and/or other material that headrests and pillows are made of and may be designed to support the head of the person on the bed. The headrest 130 may include vertical side supports to keep the person's head from falling uncomfortably far to the side or down toward the person's shoulder.

The bed 100 may be thicker at the head than the foot. This may be caused both by the inclusion of the headrest 130 at the head of the bed and by the primary mattress 110 being thicker at the head than the foot (about 15-20 inches compared to about 8-12 inches, respectively, in some embodiments). A top of the primary mattress 110 and/or the mattress topper 120 may have a slope of about 5-20 degrees. The slope can be helpful in several ways. First the slope in conjunction with the first opening 152 causes more weight to be supported by the glutes so that less weight is pressed into the parts of the person's body over and to the sides of the first opening 152. For all but the most emaciated of people, the glutes provide sufficient compressible tissue that supporting a portion of the person's body weight on the glutes will not cause loss of circulation that will cause bed sores. Also, this improves the comfort of the person who will feel less like they are falling into the first opening because weight pressing into the first opening is reduced.

The bed 100 may have a total length less than the height of the person (in some examples about 40-50 inches) and may be designed to be placed on a mattress (not shown) or other similar comfortable rest. The feet of the person may be on the mattress or other similar comfortable rest. This helps to reduce the total height and weight of the bed and also helps with comfort. The width of the bed 100 may be about 30-50 inches in some embodiments.

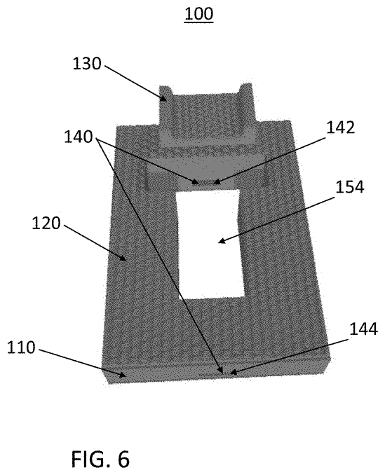

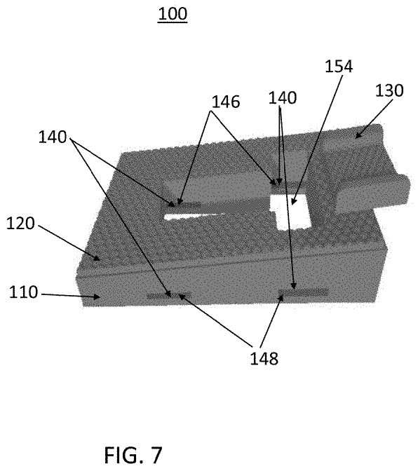

FIGS. 6 and 7 show an example second bed 100. FIG. 6 shows an example top-front view of a second bed 100. FIG. 7 shows an example side-top view of the second bed 100. The second bed 100 and the first bed 100 may be substantially similar except the shape of the first opening 154 in the second bed 100 may be different from the shape of the first opening 152 in the first bed 100.

The first opening 154 may have a “T” shape with additional width at the thoracic region about 18-24 inches. If a patient has bed sores at the exterior (i.e., side away from the spine) side of the scapula (which is less common than having sores at the interior side of the scapula) or a large amount of bed sores in the thoracic region or very large bed sores in the thoracic region, the person may need all pressure to be removed from the area. Thus, a wider opening at the thoracic region may be needed. To compensate for the reduced support at the thoracic region, the width of the opening at the tail of the “T” shape may be reduced (about 8-12 inches) at the lumbar area (compared to the first opening 152 of the first bed 100) to provide additional support at the sides of the person.

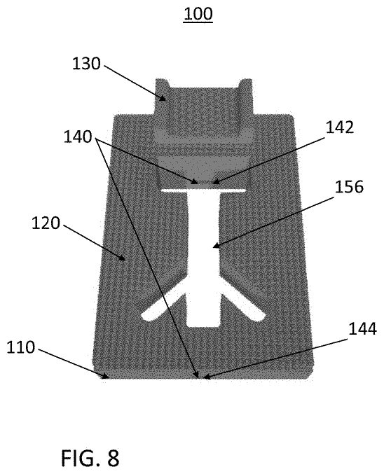

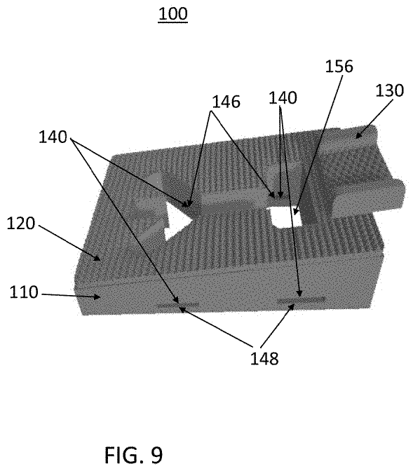

FIGS. 8 and 9 show an example third bed 100. FIG. 8 shows an example top-front view of the third bed 100. FIG. 9 shows an example side-top view of the third bed 100. The third bed 100 and the first bed 100 may be substantially similar except the shape of the first opening 156 in the third bed 100 may be different from the shape of the first opening 152 in the first bed 100.

The first opening 156 may have a shape with a “T” shape above the lumbar area and three extensions below the lumbar area. The three extensions may spread out about thirty degrees from each other. The area below the lumbar area may be designed to have weight supported on the glutes (in the areas of the mattress topper 120 and primary mattress 110 between the extensions on the portion of the first opening 156 below the lumbar area) with the exclusion of the hips, and coccyx. If a person has bed sores on the exterior portion of the hips, the person may need to have an opening such as the first opening 156 of the third bed 100 to relieve pressure on the hips and coccyx. Because so much of a person's weight (especially for women) is centered on this area and because the portion of the hips with very little tissue between the bones and skin extends all the way to and around the sides of the person, the weight should be supported directly at the glutes rather than trying to have the entire area suspended. Thus, the gaps between the extensions of the foot portion (i.e., portion closer to the foot of the third bed 100) of the first opening 156 are important for proper support of the person.

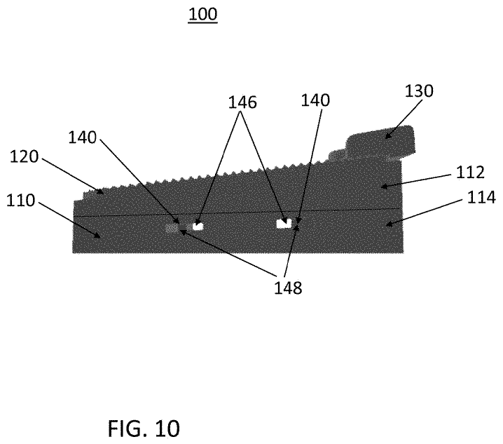

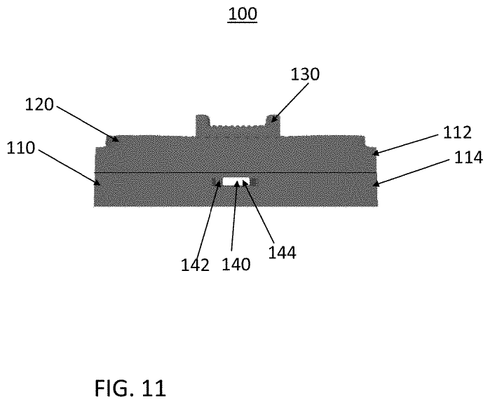

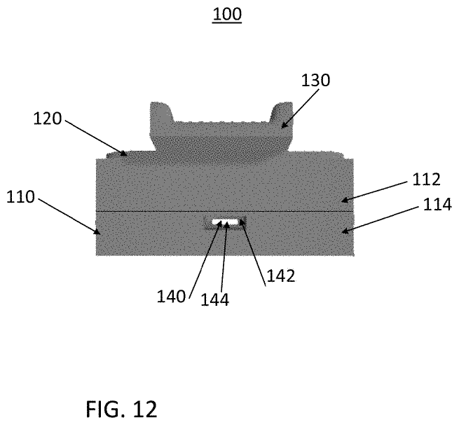

FIGS. 10-12 show an example fourth bed 100. FIG. 10 shows an example side view of the fourth bed 100. FIG. 11 shows an example foot view of the fourth bed 100. FIG. 12 shows an example head view of the fourth bed 100. The fourth bed may have any first opening 152, 154, 156 and may be substantially similar to the first, second, and third beds 100 except that the primary mattress may have two portions, an upper portion 112 and a lower portion 114. The upper portion 112 may be above and aligned with the lower portion 114. The lower portion 114 may be stiffer than the upper portion 112. As one example, the upper portion 112 includes a first foam and the lower portion 114 may include a second foam which is stiffer than the first foam. As a second example, the lower portion may have a frame similar to the frame of a box spring mattress. The second openings 140 may be openings in the lower portion 114.

The primary mattress 110 with the upper portion 112 and the lower portion 114 may advantageously have more consistent support across the body. The second openings 140 may cause the person to feel a difference in support in areas directly above the second openings 140. Having the openings in a stiffer material (especially in the case of the lower portion 114 having a frame) can cause this feeling to be reduced or eliminated without reducing the comfort of the person.

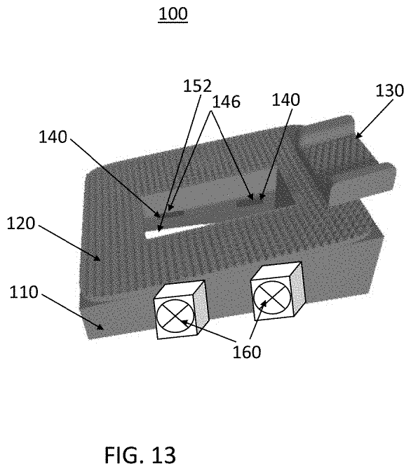

FIG. 13 shows an example side-top view of a fifth bed 100. The fifth bed 100 may be substantially the same as the first bed 100 except that the fifth bed 100 includes air circulation devices 160 such as fans, air conditioners, or other devices that move air. The air circulation devices 160 may be arranged to cause air to move through the second openings to increase air circulation on the portion of the person over the first opening 152. The air circulation devices 160 (as well as any other devices and features) may be combined with any other configurations or features discussed herein or connected by any method known by those of ordinary skill in the art.

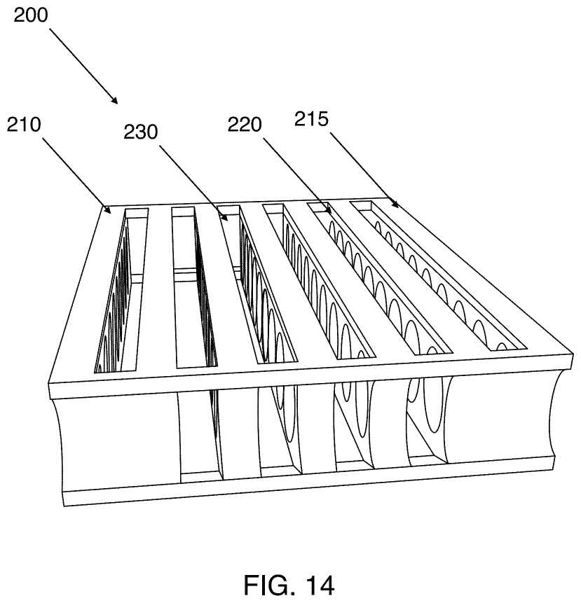

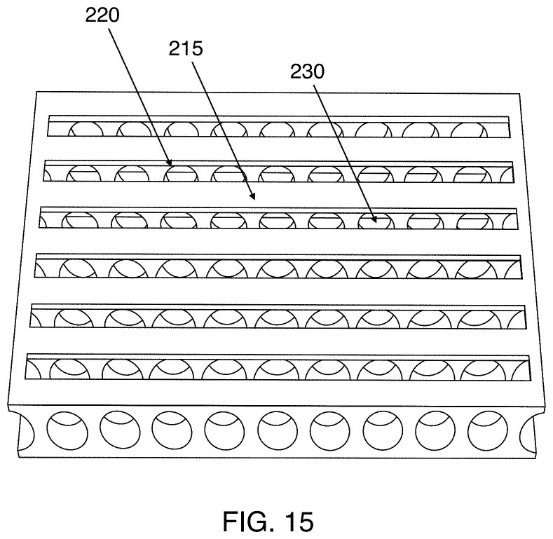

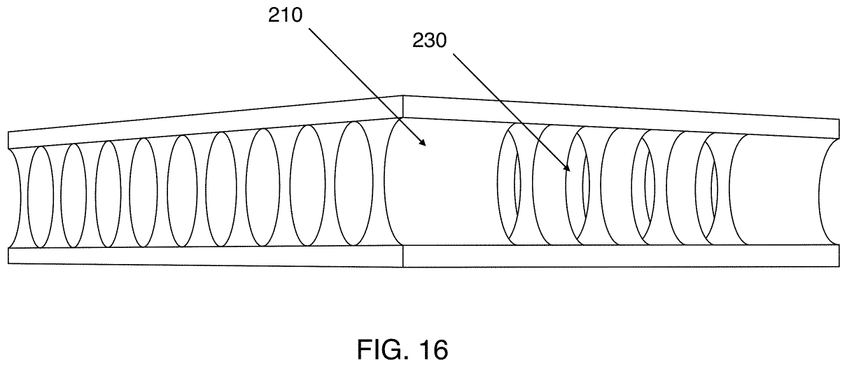

FIGS. 14-16 show an example bed 200. FIG. 14 shows an example top-front view of a bed 200. FIG. 15 shows an example side-top view of the bed 200. FIG. 16 shows an example side view of the bed 200. Bed 200 may include a primary mattress 210 as well as a mattress topper 120, and a headrest 130 similar to the other embodiments. The primary mattress 210 may having a plurality of downward extending panels 215 that extend from a top of primary mattress 210 to a bottom of primary mattress 210. Panels 215 may have an elongated rectangular or pillar shape with concave surfaces pointing inward at the forward and back portions.

The spacing between panels 215 may form a plurality of slots 220 or channels or gaps extending along the long length of the primary mattress 210 and through (entirely or at least partially through) primary mattress 210 whereby slots 220 face the top of primary mattress 210 and the bottom of primary mattress 210. The panels 215 may cover slots 220 near or at the sides of the primary mattress 210. The primary mattress 110 may define a plurality of openings 230 that are centrally located on panels 215 and extend horizontally from a first exterior side of panels 215 to a second exterior side opposite of the first exterior side (thus facing the sides of primary mattress 210). Openings 230 connect to slots 220 and are perpendicular to one another. The openings may be oval shape and may have the shape of the two concave surfaces combined; however, this is non-limiting and may be any suitable shape such as a circle, square, triangle.

In one non-limiting embodiment, there may be seven panels 215 and six slots with the two left most panels 215 connect to a covering portion 245 that covers the ends of the left most slot 220 and the two right most panels connect to a covering portion 245 that covers the ends of the right most slot 220, creating thicker wider concave portions. In this embodiment there may be nine openings 230.

Accordingly, the present description provides for various embodiments for beds 100, 200. Many uses and advantages are offered by the beds 100, 200 as described above in one or more non-limiting embodiments in the present description.

The corresponding structures, materials, acts, and equivalents of any means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention, according to one or more embodiments described in the present description, may be practiced with modification and alteration within the spirit and scope of the appended claims. Thus, the description is to be regarded as illustrative instead of restrictive of the present invention.

What is claimed is:

1. A bed comprising:
a mattress defining a first opening and a second opening, wherein the first opening extends vertically and the second opening extends horizontally and, wherein the first opening and the second opening connect such that air flows through the first opening and the second opening.

2. The bed of claim 1, wherein the mattress includes an upper portion and a lower portion, wherein the upper portion is above and aligned with the lower portion, wherein the upper portion includes a first material and the lower portion includes a second material and the second material is stiffer than the first material.

3. The bed of claim 1, further comprising:
a headrest connected to the mattress at a head of the mattress, wherein the mattress is thicker at the head of the mattress than at a foot of the mattress.

4. The bed of claim 1, wherein the mattress includes a plurality of second openings in the mattress including the second opening.

5. The bed of claim 1, further comprising:
an air moving device configured to move the air through the second opening.

6. A bed comprising:
a mattress defining one or more first openings, wherein the one or more first openings extend vertically downward from a top of the mattress.

7. The bed of claim 6, further comprising one or more second openings extends horizontally sideways through the mattress.

8. The bed of claim 6, further comprising:
a headrest connected to the mattress at a head of the mattress.

9. The bed of claim 6, further comprising:
wherein the mattress is thicker at a head of the mattress than at a foot of the mattress.

10. The bed of claim 6, wherein the one or more first openings are rectangular in shape.

11. The bed of claim 6, wherein the one or more first openings are t-shaped.

12. The bed of claim 6, wherein the one or more first openings have a t-shaped component with two prongs extending diagonally outward from the t-shaped component.

13. The bed of claim 6, further comprising a mattress topper with a third opening that is aligned with the one or more first openings.

14. The bed of claim 7, wherein the one or more second openings extend outward to all sides of the mattress.

15. The bed of claim 7, wherein the one or more second openings are 4-6 inches wide and 2-3 inches high, wherein the one or more first openings are of a size smaller than a user.

16. The bed of claim 13, wherein a foam of the mattress topper is more compressible than a second foam of the mattress.

17. The bed of claim 6, wherein the bed is thicker at a head than a foot.

18. A bed comprising:
a mattress defining one or more first openings and one or more second openings, wherein the one or more first openings extend vertically and the one or more second openings extend horizontally and, wherein the one or more first openings and the one or more second openings connect such that air flows through the one or more first openings and the one or more second openings.

19. The bed of claim 18, wherein the mattress has one or more panels positioned adjacent to the one or more first openings, wherein there are multiple second openings of the one or more second openings on sides of the one or more panels, wherein the one or more panels have an elongated rectangular shape middle portion extending outward into concave portions.

20. The bed of claim 19, wherein a first set of covering portions are positioned between two left most panels of the one or more panels, wherein the first set of covering portions cover ends of a left most opening of the one or more first openings and wherein a second set of covering portions are positioned between two right most panels of the one or more panels, wherein the second set of covering portions cover ends of a right most opening of the one or more first openings, wherein the first set of covering portions and the second set of covering portions form wider sections of the concave portions.
